(19) United States
(12) Patent Application Publication
(10) Pub. No.: US 2010/0057328 A1
(43) Pub. Date: Mar. 4, 2010

(54) LEAN NITROGEN OXIDE EMISSION CONTROL SYSTEM AND METHOD

(75) Inventors: DAVID B. BROWN, BRIGHTON, MI (US); DAVID J. CLEARY, SHANGHAI (CN); WEI LI, TROY, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., DETROIT, MI (US)

(21) Appl. No.: 12/248,246

(22) Filed: Oct. 9, 2008

Related U.S. Application Data
(60) Provisional application No. 61/092,816, filed on Aug. 29, 2008.

(51) Int. Cl. F02D 41/00; F01N 3/00

(52) U.S. Cl. 701/103; 60/285

(57) ABSTRACT

A control system comprising an NH₃ storage level determination module that determines an NH₃ storage level in an exhaust system, and a fuel control module that controls an air-to-fuel (A/F) ratio in an engine based on the NH₃ storage level. A method comprising determining an NH₃ storage level in an exhaust system, and controlling an A/F ratio in an engine based on the NH₃ storage level.

### CROSS-REFERENCE TO RELATED APPLICATIONS

This application claims the benefit of U.S. Provisional Application No. 61/092,816, filed on Aug. 29, 2008. The disclosure of the above application is incorporated herein by reference.

### FIELD

The present disclosure relates to emissions control systems and methods for internal combustion engines, and more particularly to lean nitrogen oxide (NOₓ) emissions control systems and methods.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Internal combustion engines may be operated at a lean air-to-fuel (A/F) ratio to improve fuel economy. Nitrogen oxide (NOₓ) emissions produced during lean operation are controlled. Selective catalytic reduction (SCR) catalysts, dosing systems, and lean NOₓ trap (LNT) catalysts are commonly used with internal combustion engines for emissions reduction.

In a typical SCR process, NOₓ reacts with a reductant which is injected by the dosing system into the exhaust gas stream to be absorbed onto an SCR catalyst. The injected dosing agent (e.g., urea) breaks down to form ammonia (NH₃). NH₃ reacts with NOₓ to reduce NOₓ into nitrogen (N₂) and water (H₂O).

LNT catalysts may absorb NOₓ from exhaust gas when the SCR unit cannot effectively reduce NOₓ emission during an engine start-up period. LNT catalysts may release the absorbed NOₓ after the exhaust gas reaches a predetermined temperature where the SCR unit can effectively convert NOₓ into N₂ and H₂O. As a result, NOₓ emission released to the atmosphere during the engine start-up period may be reduced.

### SUMMARY

The present disclosure provides a control system comprising an NH₃ storage level determination module that determines an NH₃ storage level in an exhaust system, and a fuel control module that controls an air-to-fuel (A/F) ratio in an engine based on the NH₃ storage level. In addition, the present disclosure provides a method comprising determining an NH₃ storage level in an exhaust system, and controlling an A/F ratio in an engine based on the NH₃ storage level.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle including an emission control system according to the principles of the present disclosure;

FIG. 2 is a functional block diagram of a control module including an ammonia (NH₃) storage level determination module and a fuel control module according to the principles of the present disclosure;

FIG. 3 is a flowchart illustrating exemplary steps of a lean nitrogen oxide (NOₓ) emission control method according to the principles of the present disclosure; and

FIG. 4 is a graph illustrating an air-to-fuel (A/F) ratio control signal, resulting cumulative inlet masses of NH₃ and NOₓ at a selective catalyst reduction (SCR) unit, and resulting NH₃ levels in the SCR unit.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

An emissions control system according to the present disclosure may include a fuel control module and a three way catalyst (TWC) disposed upstream from a selective catalyst reduction (SCR) unit. The fuel control module modulates an air-to-fuel (A/F) ratio in an engine based on a NH₃ storage level. Nitrogen oxide (NOₓ) reacts with other exhaust emissions at the TWC to yield ammonia (NH₃) during rich operation. The SCR unit stores NH₃ from exhaust gas. Stored NH₃ reacts with NOₓ in the exhaust gas to yield nitrogen (N₂) and water (H₂O) during lean operation. As a result, NOₓ emissions released to the atmosphere during lean operation may be reduced.

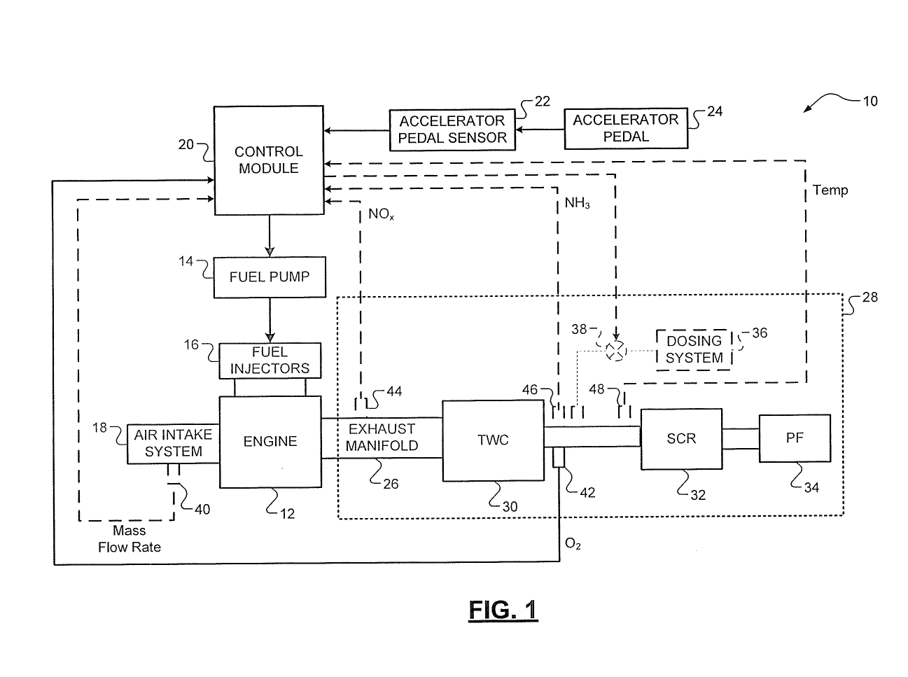

Referring now to FIG. 1, a vehicle 10 including an emission control system in accordance with the principles of the present disclosure is shown. Fuel is delivered to an engine 12 from a fuel pump 14 through a plurality of fuel injectors 16. Air is delivered to the engine 12 through an air intake system 18.

A control module 20 communicates with an accelerator pedal sensor 22. The accelerator pedal sensor 22 sends a signal representative of a pedal position of an accelerator pedal 24 to the control module 20. The control module 20 uses the pedal position signal in controlling operation of the fuel pump 14 and the fuel injectors 16.

Exhaust is produced through the combustion process and is exhausted from the engine 12 into an exhaust manifold 26. An exhaust system 28 receives the exhaust from the engine 12 through the exhaust manifold 26 and treats the exhaust flowing therethrough to reduce emissions, such as NOₓ, HC, and CO, before the exhaust is released to the atmosphere.

The exhaust system 28 includes a three way catalyst (TWC) 30 and a SCR unit 32. The exhaust system 28 may include a particulate filter (PF) 34, a dosing system 36, and a valve 38. The PF 34 removes particulate matter or soot from the exhaust downstream of the SCR unit 32. The dosing system 36 contains a reductant additive, such as urea. The control module 20 controls the valve 38 to release precise amounts of the reductant additive from the dosing system 36 into the exhaust stream. The gaseous or liquid reductant is added to the exhaust and is absorbed onto the SCR unit 32.

The TWC 30 and the SCR unit 32 remove NOₓ and other emissions in the exhaust through chemical reactions. At the TWC 30, nitrogen oxide (NOₓ) reacts with carbon monoxide (CO), hydrogen (H₂), hydrocarbons (HC), and water (H₂O) in the exhaust to yield ammonia (NH₃) when an air-to-fuel (A/F) ratio in the engine 12 is rich. The SCR unit 32 stores NH₃ produced in the TWC 30. The stored NH₃ and an SCR catalyst in the SCR unit 32 react with NOₓ in the exhaust to yield nitrogen (N₂) and H₂O when the A/F ratio in the engine 12 is lean.

The SCR unit 32 may remove NOₓ in the exhaust through a chemical reaction between the exhaust gases, the reductant additive (e.g. urea), and the SCR catalyst. Heat in the exhaust stream causes the aqueous urea solution to decompose into NH₃ and hydro-cyanic acid (HNCO). These decomposition products enter the SCR unit 32, where the HNCO further decomposes into gas phase NH₃ and the gas phase NH₃ is absorbed. The absorbed NH₃ reacts with NOₓ in the exhaust to form H₂O and N₂.

The SCR unit 32 may store NH₃ produced in the TWC 30 most effectively (i.e., nearly 100%) when the SCR unit 32 is within an optimal temperature range. The optimal temperature range may depend on a number of factors, including a SCR catalyst type or coating. For example only, the optimal temperature range may be approximately between 250° C. and 350° C.

The air intake system 18 may include an airflow meter 40 that detects an air mass flow rate. The exhaust system 28 includes an oxygen (O₂) sensor 42 that detects an O₂ concentration in the exhaust downstream of the TWC 30. The exhaust system 28 may include a NOₓ sensor 44, a NH₃ sensor 46, and a temperature sensor 48. The NOₓ sensor 44 detects a NOₓ concentration in the exhaust at the exhaust manifold 26. The NH₃ sensor 46 detects a NH₃ concentration in the exhaust downstream of the TWC 30. The temperature sensor 48 may detect an exhaust temperature between the SCR unit 32 and the TWC 30, as depicted in FIG. 1. Alternatively, the temperature sensor 48 may detect an exhaust temperature in the SCR unit 32 or the TWC 30.

The control module 20 controls the A/F ratio in the engine 12 via the fuel pump 14 and the fuel injectors 16 based on the NH₃ storage level. The control module 20 receives the O₂ concentration from the O₂ sensor 42. The control module 20 may receive the air mass flow rate from the airflow meter 40, the NOₓ concentration from the NOₓ sensor 44, the NH₃ concentration from the NH₃ sensor 46, and the exhaust temperature from the temperature sensor 48.

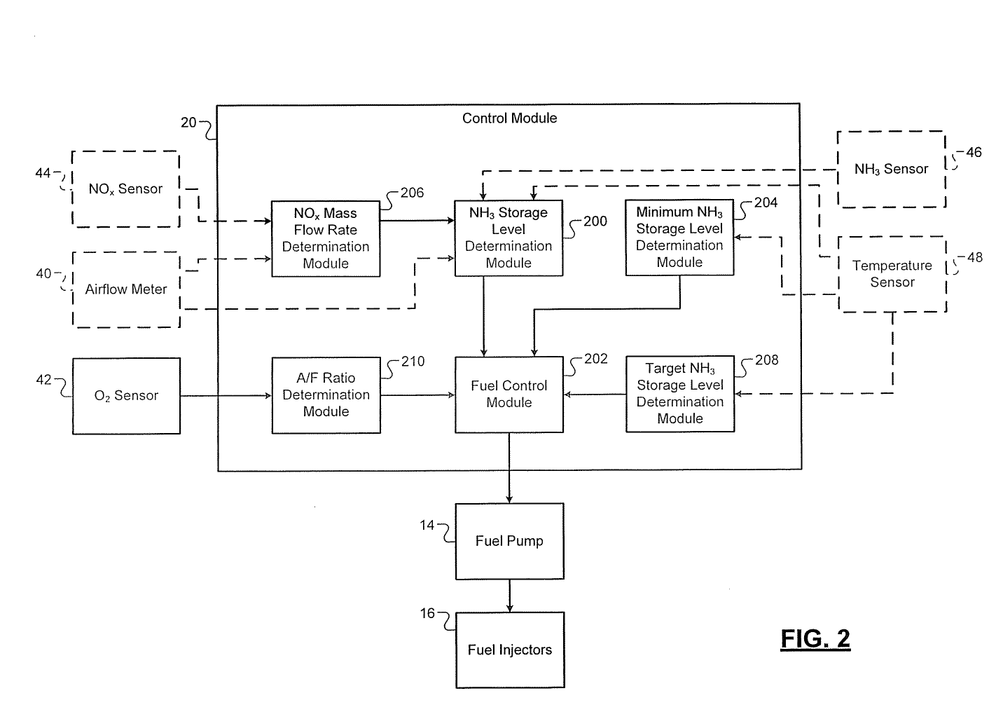

Referring now to FIG. 2, the control module 20 includes an NH₃ storage level determination module 200, a fuel control module 202, a minimum NH₃ storage level determination module 204, a NOₓ mass flow rate determination module 206, a target NH₃ storage level determination module 208, and an air-to-fuel (A/F) ratio determination module 210. The NH₃ storage level determination module 200 determines a NH₃ storage level in the exhaust system 28 based on a previous NH₃ storage level and a change in the NH₃ storage level. The fuel control module 202 controls an A/F ratio in the engine 12 via the fuel pump 14 and the fuel injectors 16 based on the NH₃ storage level determined by the NH₃ storage level determination module 200.

The minimum NH₃ storage level determination module 204 may determine a minimum NH₃ storage level based on the exhaust temperature from the temperature sensor 48. Alternatively, the minimum NH₃ storage level determination module 204 may estimate the exhaust temperature based on engine operating conditions (e.g., temperature, pressure, O₂ content) and determine the minimum NH₃ storage level based on the estimated exhaust temperature. The minimum NH₃ storage level determination module 204 provides the minimum NH₃ storage level to the fuel control module 202.

The NOₓ mass flow rate determination module 206 may determine a NOₓ mass flow rate based on the NOₓ concentration from the NOₓ sensor 44, the air mass flow rate from the airflow meter 40, and a fuel mass flow rate. The fuel mass flow rate may be determined based on a control signal from the fuel control module 202 to the fuel injectors 16 and/or based on an A/F sensor located upstream from the TWC 30.

Alternatively, the NOₓ mass flow rate determination module 206 may estimate the NOₓ concentration, the air mass flow rate, and the fuel mass flow rate, then determine the NOₓ mass flow rate based on the estimated NOₓ concentration, the estimated air mass flow rate, and the estimated fuel mass flow rate. The NOₓ concentration, the air mass flow rate, and the fuel mass flow rate may be estimated based on the engine operating conditions. Estimating the NOₓ concentration based on the engine operating conditions is disclosed in U.S. Pat. No. 6,775,623, which is incorporated herein by reference. The NOₓ mass flow rate determination module 206 provides the NOₓ mass flow rate to the NH₃ storage level determination module 200.

The target NH₃ storage level determination module 208 may determine a target NH₃ storage level based on the air mass flow rate from the airflow meter 40, the fuel mass flow rate from the fuel control module 202, and the exhaust temperature from the temperature sensor 48. Alternatively, the target NH₃ storage level determination module 208 may estimate the air mass flow rate, the fuel mass flow rate and the exhaust temperature based on the engine operating conditions and determine the target NH₃ storage level based thereon. The target NH₃ storage level may be calculated such that its magnitude is above the minimum NH₃ storage level and below the NH₃ saturation point of the SCR unit 32. For example only, the target NH₃ storage level may be set within a range from 20% to 30% below the NH₃ saturation point of the SCR unit 32. The target NH₃ storage level determination module 204 provides the target NH₃ storage level to the fuel control module 202.

The A/F ratio determination module 210 determines a post TWC A/F ratio (i.e., A/F ratio of the exhaust downstream of the TWC 30) based on the O₂ concentration from the O₂ sensor 42. High levels of O₂ concentration indicate a lean A/F ratio, while low levels of O₂ concentration indicate a rich A/F ratio. The A/F ratio determination module 210 provides the post TWC A/F ratio to the fuel control module 202.

The fuel control module 202 determines whether the NH₃ storage level is greater than the minimum NH₃ storage level. When the NH₃ storage level is greater than the minimum NH₃ storage level, the fuel control module 202 sets the A/F ratio in the engine 12 to lean and the NH₃ storage level determination module 200 determines a decrease in the NH₃ storage level based on the NOₓ mass flow rate from the NOₓ mass flow rate determination module 206. More specifically, the NH₃ storage level determination module 200 may calculate the decrease in the NH₃ storage level based on an assumed relationship of 0.5 gram of NH₃ consumed for each gram of NOₓ detected, which may be modified based on the exhaust temperature from the temperature sensor 48 and a SCR catalyst type.

When the NH₃ storage level is less than the minimum NH₃ storage level, the fuel control module 202 sets the A/F ratio in the engine 12 to rich and the A/F ratio determination module 210 determines whether the post TWC A/F ratio is rich. When the post TWC A/F ratio is not rich, the fuel control module 202 continues to monitor the NH₃ storage level to determine whether the A/F ratio may be set to lean. When the post TWC A/F ratio is rich, the NH₃ storage level determination module 200 determines an increase in the NH₃ storage level based on the NOₓ mass flow rate from the NOₓ mass flow rate determination module 206 and the fuel control module 202 determines whether the NH₃ storage level exceeds the target storage level. The NH₃ storage level determination module 200 may also determine the increase in the NH₃ storage level based on the A/F ratio and the exhaust temperature from the temperature sensor 48.

The NH₃ storage level determination module 200 may determine the increase in the NH₃ storage level based on the NOₓ mass flow rate from the NOₓ mass flow rate determination module 206. More specifically, the NH₃ storage level determination module 200 may calculate the increase in the NH₃ storage level based on a relationship of 0.5 grams of NH₃ produced for each gram of NOₓ detected, which may be modified based on the exhaust temperature from the temperature sensor 48. Alternatively, the NH₃ storage level determination module 200 may determine the increase in the NH₃ storage level based on the NH₃ concentration from the NH₃ sensor 46, the air mass flow rate from the airflow meter 40, and the fuel mass flow rate from the fuel control module 202.

When the NH₃ storage level does not exceed the target storage level, the NH₃ storage level determination module 200 continues to determine the increase in the NH₃ storage level based on the NOₓ mass flow rate. When the NH₃ storage level exceeds the target storage level, the fuel control module 202 again determines whether the A/F ratio may be set to lean. When the A/F ratio may be set to lean, the fuel control module 202 sets the A/F ratio in the engine 12 to lean and monitors the NH₃ storage level. When the A/F ratio may not be set to lean, the fuel control module 202 sets the A/F ratio in the engine 12 to stoichiometric and continues to monitor the lean burn conditions to determine whether the A/F ratio may be set to lean.

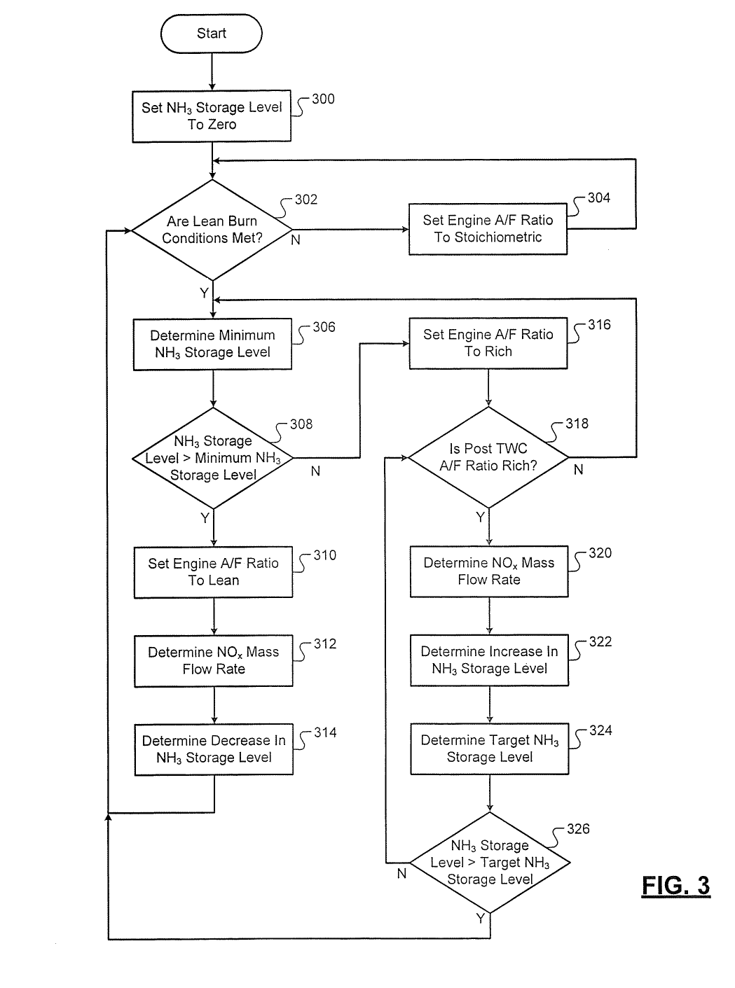

Referring now to FIG. 3, a flowchart illustrates exemplary steps of a lean NOₓ emission control method according to the principles of the present disclosure. In step 300, control sets the NH₃ storage level to zero. In step 302, control determines whether lean burn conditions are met. Lean burn conditions may be met when predetermined service indicators are not set and when coolant temperatures, catalyst temperatures, an engine mode, and an engine run time meet predetermined criteria.

When lean burn conditions are not met, control sets the A/F ratio to stoichiometric and continues to determine whether lean burn conditions are met. When lean burn conditions are met, control determines a minimum NH₃ storage level and determines whether the NH₃ storage level exceeds the minimum NH₃ storage level in steps 306 and 308, respectively. Control may determine the minimum NH₃ storage level based on a measured exhaust temperature. Alternatively, control may estimate the exhaust temperature based on the engine operating conditions and determine the minimum NH₃ storage level based on the estimated exhaust temperature.

When the NH₃ storage level exceeds the minimum NH₃ storage level, control sets the A/F ratio to lean in step 310, determines a NOₓ mass flow rate in step 312, and determines a decrease in the NH₃ storage level in step 314. Control determines the NOₓ mass flow rate based on an air mass flow rate, a fuel mass flow rate, and a NOₓ concentration, which may be measured or estimated. Control may determine the decrease in the NH₃ storage level based on the NOₓ mass flow rate, the exhaust temperature and a SCR catalyst type. When the decrease in the NH₃ storage level is determined, control returns to step 302.

When the NH₃ storage level does not exceed the minimum NH₃ storage level, control sets the A/F ratio to rich in step 316 and determines whether the post TWC A/F ratio is rich in step 318. When the post TWC A/F ratio is not rich, control returns to step 306. When the post TWC is rich, control determines the NOₓ mass flow rate in step 320, determines an increase in the NH₃ storage level in step 322, and determines the target NH₃ storage level in step 324. Control may determine the increase in the NH₃ storage level based on the NOₓ mass flow rate, the A/F ratio, and the exhaust temperature. Alternatively, control may determine the increase in the NH₃ storage level based on the NH₃ concentration, the air mass flow rate, and the fuel mass flow rate. Control may calculate the target NH₃ storage level such that its magnitude is above the minimum NH₃ storage level and below the NH₃ saturation point of the SCR unit 32. For example only, control may set the target NH₃ storage level within a range from 20% to 30% below the NH₃ saturation point of the SCR unit 32.

In step 326, control determines whether the NH₃ storage level exceeds the target NH₃ storage level. When the NH₃ storage level does not exceed the target NH₃ storage level, control returns to step 318 and continues to monitor the NH₃ storage level. When the NH₃ storage level exceeds the target NH₃ storage level, control returns to step 302.

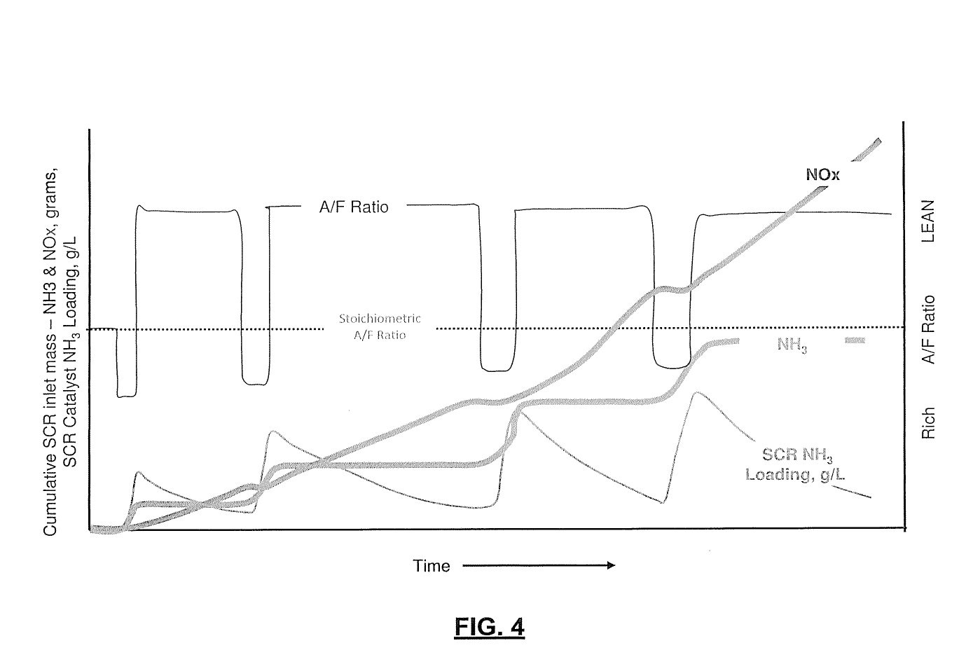

Referring now to FIG. 4, a graph illustrates an A/F ratio control signal, resulting cumulative inlet masses of NH₃ and NOₓ at the SCR unit, and resulting NH₃ levels in the SCR unit. The A/F ratio control signal modulates between lean and rich operation. However, the A/F ratio control signal is normally modulated to lean operation to improve fuel economy.

As discussed above, the TWC catalyst reacts with NOₓ and other exhaust emissions during rich operation to yield NH₃ that is stored in the SCR unit, and the stored NH₃ subsequently reacts with NOₓ in the exhaust to yield N₂ and H₂O during lean operation. Thus, the cumulative inlet mass of NH₃ at the SCR unit increases during rich operation and the cumulative inlet mass of NOₓ at the SCR unit increases during lean operation. In addition, the NH₃ levels in the SCR unit increase during rich operation and decrease during lean operation.

The A/F ratio may be modulated between lean and rich such that the lean NOₓ (i.e., NOₓ produced during lean operation) is balanced with the rich NOₓ (i.e., NOₓ produced during rich operation) and the mass of NH₃ consumed during lean operation is balanced with the mass of NH₃ produced during rich operation. The A/F ratio control signal depicted is biased to result in a slight excess of NH₃ emissions and ensure robust NOₓ reduction. Modulating the A/F ratio to balance the NOx and NH₃ results in effective NOx reduction without excess emissions or fuel consumption. In addition, balancing the NOₓ and NH₃ may enable the elimination of a LNT and a dosing system, or reduce the amount of dosing agent that must be injected for adequate NOₓ reduction. Modulating the A/F ratio to rich for extended durations may worsen fuel economy and increase the NH₃ levels above the NH₃ storage capacity of the SCR unit, resulting in excess HC and CO emissions. Modulating the A/F ratio to lean for extended durations may deplete the NH₃ storage level, resulting in excess NOₓ emissions.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A control system, comprising:
an NH₃ storage level determination module that determines an NH₃ storage level in an exhaust system; and
a fuel control module that controls an air-to-fuel (A/F) ratio in an engine based on said NH₃ storage level.

2. The control system of claim 1 further comprising a minimum NH₃ storage level determination module that determines a minimum NH₃ storage level based on an exhaust temperature.

3. The control system of claim 2 wherein said fuel control module sets said A/F ratio to lean when said NH₃ storage level exceeds said minimum NH₃ storage level.

4. The control system of claim 2 wherein said fuel control module sets said A/F ratio to rich when said NH₃ storage level does not exceed said minimum NH₃ storage level.

5. The control system of claim 1 further comprising a target NH₃ storage level determination module that determines a target NH₃ storage level based on an exhaust temperature.

6. The control system of claim 5 wherein said fuel control module sets said A/F ratio to lean when said NH₃ storage level exceeds said target NH₃ storage level.

7. The control system of claim 1 further comprising a NOₓ mass flow rate determination module that determines a NOₓ mass flow rate based on a NOₓ concentration.

8. The control system of claim 7 wherein said NH₃ storage level determination module determines a change in said NH₃ storage level based on said NOₓ mass flow rate.

9. The control system of claim 8 wherein said NH₃ storage level determination module determines said change in said NH₃ storage level further based on at least one of an exhaust temperature, a catalyst type, and said A/F ratio.

10. The control system of claim 8 wherein said NH₃ storage level determination module determines said NH₃ storage level based on a previous NH₃ storage level and said change in said NH₃ storage level.

11. A method, comprising:
determining an NH₃ storage level in an exhaust system; and
controlling an air-to-fuel (A/F) ratio in an engine based on said NH₃ storage level.

12. The method of claim 11 further comprising determining a minimum NH₃ storage level based on an exhaust temperature.

13. The method of claim 12 further comprising setting said A/F ratio to lean when said NH₃ storage level exceeds said minimum NH₃ storage level.

14. The method of claim 12 further comprising setting said A/F ratio to rich when said NH₃ storage level does not exceed said minimum NH₃ storage level.

15. The method of claim 11 further comprising determining a target NH₃ storage level based on an exhaust temperature.

16. The method of claim 15 further comprising setting said A/F ratio to lean when said NH₃ storage level exceeds said target NH₃ storage level.

17. The method of claim 11 further comprising determining a NOₓ mass flow rate based on a NOₓ concentration.

18. The method of claim 17 further comprising determining a change in said NH₃ storage level based on said NOₓ mass flow rate.

19. The method of claim 18 further comprising determining said change in said NH₃ storage level further based on at least one of an exhaust temperature, a catalyst type, and said A/F ratio.

20. The method of claim 18 further comprising determining said NH₃ storage level based on a previous NH₃ storage level and said change in said NH₃ storage level.
